(19) United States
(12) Patent Application Publication
(10) Pub. No.: US 2006/0095547 A1
(43) Pub. Date: May 4, 2006

(54) Storage configuration loader using cache for fast retrieval of storage configurations

(75) Inventor: Jeremy Andrew Cohn, Tucson, AZ (US)

Correspondence Address: Allen K. Bates;International Business Machines Corporation, 9000 South Rita Road, Tucson, AZ, 85744, US

(73) Assignee: International Business Machines Corporation, Armonk, NY (US)

(21) Appl. No.: 10/983,444

(22) Filed: Nov. 8, 2004

(51) Int. Cl. G06F 15/177

(52) U.S. Cl. 709/220

(57) ABSTRACT

Disclosed are a system, a method, and article of manufacture for managing configuration information for information storage and retrieval systems. A configuration loader user interface permits a user to send and receive command with respect to a configuration loader. The configuration loader obtains the configuration of the information storage and retrieval system configuration source and stores the configuration in the database. The configuration loader monitors the information storage and retrieval system configuration source to detect a change in the configuration. Upon detecting a change in the configuration of the configuration source, the configuration loader stores the change in the configuration in a cache portion of the database. The configuration loader retrieves the configuration of the information storage and retrieval system configuration source from the database and the cache portion when needed.

### CROSS-REFERENCES TO RELATED APPLICATIONS

The present application is related to application Ser. No. ______, entitled “Storage Configuration Loader: verification algorithms”, Docket # TUC9-2004-00069, application Ser. No. ______, entitled “Storage Configuration Loader”, Docket # TUC9-2004-00079 and application Ser. No. ______, entitled “Storage Configuration Loader With Automatic Error Recovery”, Docket # TUC9-2004-00081, all filed on an even date herewith, the disclosures of which are hereby incorporated by reference in their entirety.

### TECHNICAL FIELD

This invention relates to an apparatus and method to configure information storage and retrieval systems.

### BACKGROUND OF THE INVENTION

Data storage and retrieval systems are used to store information provided by one or more host computer systems. Such data storage and retrieval systems receive requests to write information to one or more secondary storage devices, and requests to retrieve information from those one or more secondary storage devices. Upon receipt of a write request, the system stores information received from a host computer in a data cache. In certain implementations, a copy of that information is also stored in a nonvolatile storage device. Upon receipt of a read request, the system recalls information from the one or more secondary storage devices and moves that information to the data cache. Thus, the system is continuously moving information to and from storage devices, and to and from the data cache.

In certain data processing applications, data is copied to multiple individual information storage and retrieval systems. Such copy service applications include, for example, peer-to-peer remote copy operations. In such applications, data is copied from an information storage and retrieval system source to a target information storage and retrieval system. Some of these copy service applications require both the source and target information storage and retrieval systems to have identical physical and logical configurations. In other data processing applications, it is advantageous to configure the source and target information storage and retrieval systems to be physically and logically similar to facilitate efficient transfer of data. Transferring configurations from a source to a target to accomplish the configuration of the target is often used to produce a target that is compatible with the source. Often a large number of logical objects must be configured at the target, resulting in a time consuming configuration process. This is most noticeable when transferring configurations from an online information storage and retrieval system to an offline information storage and retrieval system.

What is needed is an apparatus and method for managing configuration information for information storage and retrieval systems to provide rapid access to configuration information.

### SUMMARY OF THE INVENTION

The present invention provides a system, a method and an article of manufacture for managing configuration information for information storage and retrieval systems.

In method form, exemplary embodiments include a method for managing configuration information for information storage and retrieval systems. The method comprises providing a configuration loader user interface for accepting configuration commands and providing a configuration loader capable of communicating with the configuration loader user interface and with an information storage and retrieval system configuration source. The configuration loader comprises an offline configuration processor, a database and a configuration loader module for obtaining a configuration of the information storage and retrieval system configuration source. The method provides that operative to the configuration loader receiving a command from the configuration loader user interface to store the configuration of the information storage and retrieval system configuration source in the database, the configuration loader module obtains the configuration of the information storage and retrieval system configuration source and sends the configuration of the information storage and retrieval system configuration source to the offline configuration processor. The offline configuration processor stores the configuration of the information storage and retrieval system configuration source in the database.

In method form, exemplary embodiments further include the configuration loader monitoring the information storage and retrieval system configuration source to detect a change in the configuration of the information storage and retrieval system configuration source. Operative to the configuration loader detecting a change in the configuration of the information storage and retrieval system configuration source, the configuration loader stores the change in the configuration of the information storage and retrieval system configuration source in a cache portion of the database.

In method form, exemplary embodiments further include operative to the configuration loader receiving a command from the configuration loader user interface to transfer the configuration of the information storage and retrieval system configuration source to a target information storage and retrieval system, the configuration loader retrieves the configuration of the information storage and retrieval system configuration source from the database and the cache portion.

In system embodiments the present invention provides a system for managing configuration information for information storage and retrieval systems. The system comprises a configuration loader user interface for accepting configuration commands and a configuration loader capable of communicating with the configuration loader user interface and with an information storage and retrieval system configuration source. The configuration loader comprises an offline configuration processor, a database and a configuration loader module for obtaining a configuration of the information storage and retrieval system configuration source. The system is adapted so that operative to the configuration loader receiving a command from the configuration loader user interface to store the configuration of the information storage and retrieval system configuration source in the database, the configuration loader module obtains the configuration of the information storage and retrieval system configuration source and sends the configuration of the information storage and retrieval system configuration source to the offline configuration processor. The offline configuration processor stores the configuration of the information storage and retrieval system configuration source in the database.

The system further comprises a cache portion and the configuration loader monitors the information storage and retrieval system configuration source to detect a change in the configuration of the information storage and retrieval system configuration source. Operative to the configuration loader detecting a change in the configuration of the information storage and retrieval system configuration source, the configuration loader stores the change in the configuration of the information storage and retrieval system configuration source in the cache portion.

These and other benefits of the present invention will be discussed in the following detailed description, which describes aspects of an exemplary system, apparatus, and procedure of the present invention. It will be appreciated by those skilled in the art that although the following detailed description will proceed with reference being made to preferred embodiments and methods of use, the present invention is not intended to be limited to these preferred embodiments and methods of use. Rather, the present invention is intended to be limited only as set forth in the accompanying claims. For a more detailed understanding of the present invention, reference may be made to the following detailed description taken in conjunction with the accompanying drawings.

### BRIEF DESCRIPTION OF THE DRAWINGS

Referring now to the drawings in which like reference numbers represent corresponding parts throughout.

FIG. 1 is an illustration of one embodiment of Applicant's data processing system.

FIG. 2 is an illustration of one embodiment of Applicant's information storage and retrieval system.

FIG. 3 is an illustration of one embodiment of Applicant's configuration loader system.

FIG. 4 is an illustration of one embodiment of Applicant's thread management system.

FIG. 5 illustrates a flowchart showing a process to implement an embodiment of the present invention for managing configuration information for information storage and retrieval systems.

FIG. 6 illustrates a flowchart showing a process to implement an embodiment of the present invention to transfer a configuration from a source to a target information storage and retrieval system.

FIG. 7 illustrates a flowchart showing a process to implement an embodiment of the present invention to transfer a configuration from a source information storage and retrieval system source to a database.

### DETAILED DESCRIPTION OF THE PREFERRED EMBODIMENTS

The present invention is described in preferred embodiments in the following description. The preferred embodiments are described with reference to the Figures. While the present invention is described in conjunction with the preferred embodiments, it will be appreciated by those skilled in the art that it is intended to cover alternatives, modifications, and equivalents as may be included within the spirit and scope of the present invention as defined by the appended claims.

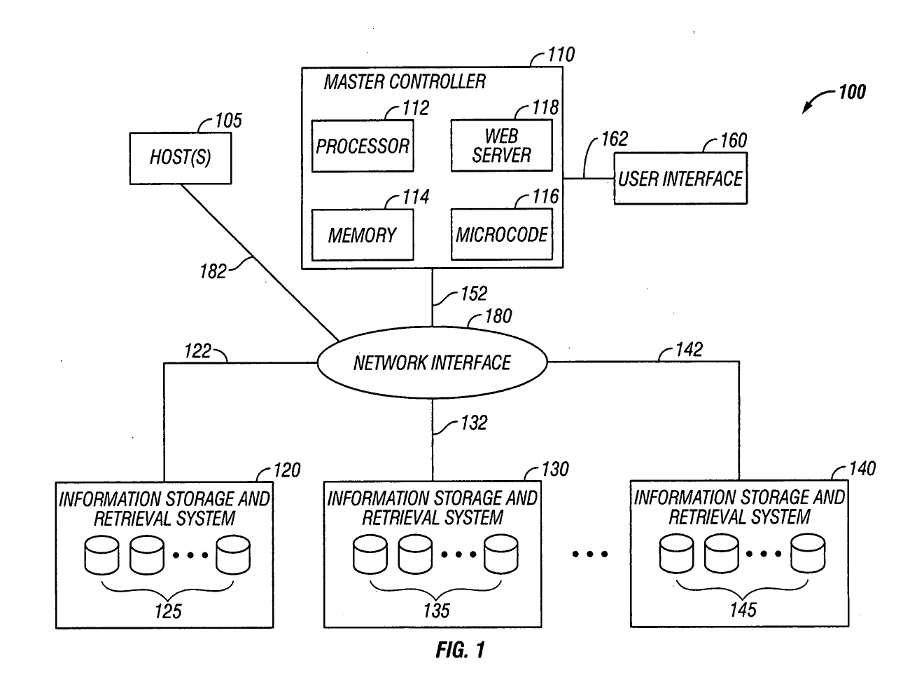

Referring now to FIG. 1, Applicant's data processing system 100 includes a master controller 110 in combination with a plurality of information storage and retrieval systems. For example, in the illustrated embodiment of FIG. 1, Applicant's data processing system 100 includes master controller 110 in combination with information storage and retrieval systems 120, 130, 140, and additional systems not shown.

In certain embodiments, Applicant's system further includes a network interface 180. Network interface 180 may be for example a Storage Attached Network (“SAN”), a local area network (LAN), a wide area network (WAN), a private network or combinations thereof. In these embodiments, master controller 110 is capable of communicating with network interface 180 via communication link 152.

Master controller 110 includes processor 112, memory 114, and microcode 116. In certain embodiments, memory 114 comprises non-volatile memory, such as for example, one or more EEPROMs (Electrically Erasable Programmable Read Only Memory), one or more flash PROMs (Programmable Read Only Memory), battery backup RAM, hard disk drive, combinations thereof, and the like.

User interface 160 communicates with master controller 110 via communication link 162. In certain embodiments, communication link 162 may be implemented as network interface 180. In certain embodiments master controller 110 may include user interface 160. In other embodiments, master controller 110 further includes web server 118 which is capable of bidirectional communication using an Internet access link to user interface 160. Host computer 105 is capable of communication with any of the components of data processing system 100 using network interface 180 via communication link 182. In other embodiments, host computer 105 may communicate with any of the components of data processing system 100 directly using for example, a host adapter.

In the illustrated embodiment of FIG. 1, master controller 110 is external to each of Applicant's information storage and retrieval systems comprising system 100. In other embodiments, master controller 110 is integral with one of the information storage and retrieval systems comprising Applicant's data processing system.

Master controller 110 is capable of bidirectional communication with information storage and retrieval systems 120, 130, and 140, using network interface 180, communication link 152 and communication links 122, 132, and 142, respectively. In the illustrated embodiment of FIG. 1, master controller 110 communicates with a plurality of information storage and retrieval systems using network interface 180, such as for example, a SAN. In other embodiments, master controller 110 may also communicate directly with any of the information storage and retrieval systems. In yet other embodiments, master controller 110 communicates directly with one or more information storage and retrieval systems, and with one or other information storage and retrieval systems using network interface 180.

Communication links 122, 132, 142, 152 162 and 182, are independently selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

Information storage and retrieval system 120 includes a plurality of information storage media 125. In certain embodiments, plurality of information storage media 125 comprises one or more hard disk drives, one or more tape storage media, one or more optical storage media, one or more electronic storage media, and combinations thereof.

Information storage and retrieval system 130 includes a plurality of information storage media 135. In certain embodiments, plurality of information storage media 135 comprises one or more hard disk drives, one or more tape storage media, one or more optical storage media, one or more electronic storage media, and combinations thereof.

Information storage and retrieval system 140 includes a plurality of information storage media 145. In certain embodiments, plurality of information storage media 145 comprises one or more hard disk drives, one or more tape storage media, one or more optical storage media, one or more electronic storage media, and combinations thereof.

As those skilled in the art will appreciate, information and retrieval storage systems 120, 130, and 140, may comprise elements in addition to the plurality of storage media shown. As those skilled in the art will further appreciate, such information storage and retrieval systems may further include, without limitation, one or more processors, one or more data buffers, one or more DASD devices, one or more data caches, one or more input/output adapters, one or more storage device adapters, one or more operator input panels, one or more web servers, one or more robotic accessors, one or more data storage devices which include the plurality of storage media 125, and the like.

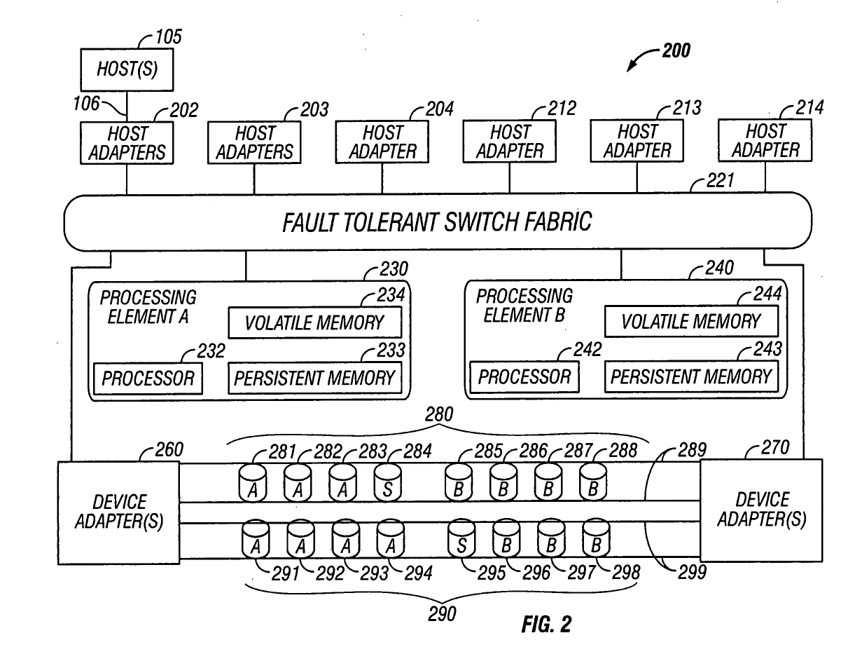

Referring now to FIG. 2, in certain embodiments, one or more of information storage and retrieval systems 120 (FIG. 1), 130 (FIG. 1) and 140 (FIG. 1) comprises information storage and retrieval system 200. Information storage and retrieval system 200 is capable of communication with host computer 105 via communication link 106. The illustrated embodiment of FIG. 2 shows a single host computer. In other embodiments, Applicant's information storage and retrieval system is capable of communicating with a plurality of host computers.

Host computer 105 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) In certain embodiments, host computer 105 further includes a storage management program. The storage management program in the host computer 105 may include the functionality of storage management type programs known in the art that manage the transfer of data to a data storage and retrieval system, such as the IBM DFSMS implemented in the IBM MVS operating system.

In certain embodiments, Applicant's information storage and retrieval system 200 includes a plurality of host adapters 202, 203, 204, 212, 213 and 214, disposed in host bays (not shown). In other embodiments, Applicant's information storage and retrieval system includes more or less than the six host adapters shown. Regardless of the number of host adapters disposed in any embodiments of Applicant's system, each of those host adapters comprises a shared resource that has equal access to both processing elements 230 and 240. Each host adapter may comprise one or more Fibre Channel ports, one or more FICON ports, one or more ESCON ports, or one or more SCSI ports or other interface protocol known in the art. Each host adapter is connected to both processing elements 230 and 240 through fault tolerant switch fabric 221 such that each processing element 230, 240 can manage I/O from any host adapter.

Processor element 230 includes processor 232, volatile memory 234 and persistent memory 233. In certain embodiments, memory devices 233, 234 comprise random access memory or non-volatile memory. Cache may be implemented in any of the elements of processor element 230.

Processor element 240 includes processor 242, volatile memory 244 and persistent memory 243. In certain embodiments, memory devices 243, 244 comprise random access memory or non-volatile memory. Cache may be implemented in any of the elements of processor element 240.

I/O to storage devices portion 260 comprises a plurality of device adapters, such as device adapters for interfacing to storage devices. I/O portion 270 further comprises a plurality of device adapters, such as device adapters for interfacing to storage devices.

In certain embodiments of Applicant's system, one or more host adapters, processor element 230 and one or more device adapters are packaged together on a single card disposed in Applicant's information storage and retrieval system. Similarly, in certain embodiments, one or more host adapters, processor element 240 and one or more device adapters are disposed on another card disposed in Applicant's information storage and retrieval system. In these embodiments, Applicant's system 200 includes two cards interconnected with a plurality of data storage devices.

In the illustrated embodiment of FIG. 2, sixteen data storage devices are organized into two arrays, namely array “A” and array “B”. The illustrated embodiment of FIG. 2 shows two storage device arrays. In other embodiments, Applicant's information storage and retrieval system includes more than two storage device arrays. Each storage array appears to a host computer as one or more logical devices.

In certain embodiments, one or more of the data storage devices comprise a plurality of hard disk drive units. In the illustrated embodiment of FIG. 2, disk array “A” includes disk drives 281, 282, 283, 291, 292, 293, and 294. Disk array “B” includes disk drives 285, 286, 287, 288, 296, 297, and 298. In certain embodiments, arrays “A” and “B” utilize a RAID (Redundant Array of Independent Disks) protocol. In certain embodiments, arrays “A” and “B” comprise what is sometimes called a JBOD array, i.e. “Just a Bunch Of Disks” where the array is not configured according to RAID. As those skilled in the art will appreciate, a RAID rank comprises independent disk drives configured in an array of disk drives to obtain performance, capacity and/or reliability that exceeds that of a single large drive. In the illustrated embodiment of FIG. 2, disks labeled “S” indicates a spare disk that may be used to replace a failed data disk. The spare disks include disk drives 284 and 295. The data disks, in this figure, are 281, 282, 283, 291, 292, 293, 294, 285, 286, 287, 288, 296, 297, and 298.

The illustrated embodiment of FIG. 2 shows two storage device arrays. In other embodiments, Applicant's system includes a single storage device array. In yet other embodiments, Applicant's system includes more than two storage device arrays.

The interface structure 289, 299 to storage devices 280, 290 shown in FIG. 2 comprises one embodiment of Applicant's system. In other embodiments, link 289 and/or 299 comprises a switched fabric or a combination of a switch and loop topologies. In other embodiments, link 289 and/or 299 comprises dual FC-AL loops of switches. Each loop contains one or more Fibre Channel switches.

In certain embodiments, one or more Applicant's information storage and retrieval systems 120, 130, 140 comprises an automated media library comprising a plurality of tape cartridges, one or more robotic accessors, and one or more tape drives. U.S. Pat. No. 5,970,030, assigned to the common assignee herein, describes such an automated media library and is hereby incorporated by reference. In certain embodiments, one or more of Applicant's information storage and retrieval systems 120, 130, 140 comprises a virtual tape system. U.S. Pat. No. 6,269,423, assigned to the common assignee herein, describes such a virtual tape system, and is hereby incorporated by reference.

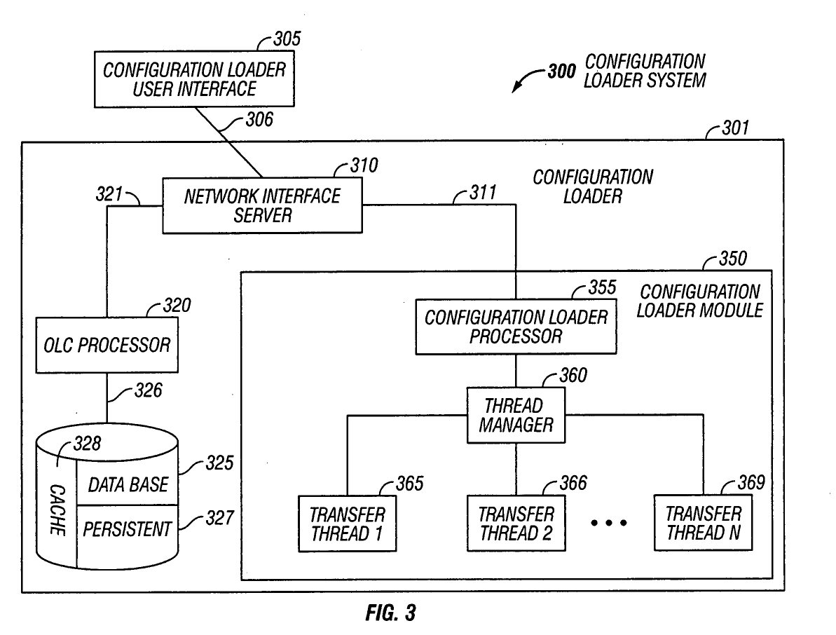

With reference to FIG. 3, a configuration loader system 300 that may be used to implement the present invention is described. The configuration loader system is responsible for loading or transferring logical and/or physical configurations from a source storage facility image (SFI) to a target SFI. The source SFI may be for example, an information storage and retrieval system configuration source. The target SFI may be for example, an information storage and retrieval system configuration target. The source or target system may be a physical system (i.e. systems 120, 130, 140) or a virtual system (i.e. a configuration stored in memory). Herein a source refers to an information storage and retrieval system configuration source and a target refers to an information storage and retrieval system configuration target.

In certain embodiments, configuration loader user interface 305 is used to allow a user to submit commands to configuration loader 301 by accepting configuration commands from a user or other source. In the preferred embodiment, the commands are sent asynchronously to configuration loader 301. After the command is sent, configuration loader 301 returns a message to the sender that the command is accepted or rejected. For example, if a command is sent to start a configuration transfer, configuration loader 301 accepts the command and returns a message to the user interface 305 indicating that the command is accepted. Configuration loader 301 may then process the command and simultaneously accept new commands. This capability allows user interface 305 to remain active (i.e. submit or receive commands and information) and not to have to wait until the first command completes before executing additional commands. In other embodiments, the commands may be transmitted synchronously. In certain embodiments, configuration loader interface 305 may be implemented on a separately network-connected computer system, such as a mainframe, personal computer, workstation, server and combinations thereof. In certain embodiments, configuration loader interface 305 may provide a graphical user interface (GUI), command line interface (CLI) or other system to allow a user to select and run configuration transfers or loads between source and target systems. In certain embodiments, configuration loader interface 305 may be implemented by user interface 160 (FIG. 1). Configuration loader interface 305 uses communication link 306 to communicate with configuration loader 301 via network interface server 310. Communication links 306, 321, 311 and 326, are independently selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, configuration loader 301 comprises network interface server 310, offline configuration processor (OLC) 320, data base 325 and configuration loader module 350. Network interface server 310 provides a network connection for the components and provides the ability to perform configurations in a network-connected fashion so that users may start configuration transfers and disconnect without interrupting the transfers. The client-server design of configuration loader user interface 305 and configuration loader 301, respectively, along with the ability to send asynchronous commands to configuration loader 301 provides the ability to disconnect configuration loader interface 305 without interrupting any configuration transfer. Network interface server 310 communicates with configuration loader module 350 and OLC processor 320 via communication links 311 and 321.

OLC processor 320 interfaces with data base 325 via communication link 326. OLC processor 320 and data base 325 provide a repository for offline storage systems configuration. OLC processor 320 allows users to create virtual configuration images for modeling and pre-planning of their storage configuration images. OLC processor 320 maintains one or more virtual configurations in a database (i.e. database 325). Herein, task list and list of tasks are used interchangeably with the same meaning. For example, if a source has a logical object (i.e. RAID Array) which needs to be transferred to a target, the configuration information that includes the object is stored in the database 325 as an offline configuration. Database 325 includes a cache 328 and persistent 327. In other embodiments, the OLC processor 320 can maintain the task list in cache memory 328. Cache memory 328 may be used for volatile fast storage of temporary data. Persistent 327 may provide nonvolatile long term storage of data. Both cache memory 328 or persistent 327, or combinations thereof, can be used to temporarily store incoming configuration object requests (i.e. adding/creating, deleting/removing, and/or modifying configuration objects) from configuration loader user interface 305 in offline configuration storage (325, 327, 328). For example, when configuration loader user interface 305 creates a logical object, such as a volume, in information storage and retrieval system 140, the volume could also be added to the offline configuration. The offline configuration could then be used as a cached copy of the actual configuration existent on information storage and retrieval system 140. This would reduce costly retrieval times for very large configurations when transferring the configuration from information storage and retrieval system 140 to a target system. The target system may be an offline or virtual configuration, of which the configuration already exists in the offline memory storage. The target system only needs to communicate with configuration loader user interface 305 to be used as a target. In another embodiment, the target may be a configuration transfer to another information storage and retrieval system.

Configuration loader module 350 is responsible for maintaining and providing controls access (i.e. start, cancel, etc.) to all configuration transfers. In certain embodiments, configuration loader module 350 comprises configuration loader processor 355, thread manager 360, and one or more transfer threads 365, 366-369. Configuration loader processor 355 provides interpretation and execution of configuration commands and reporting of the status of the system to/from configuration loader interface 305. In the preferred embodiment the status is reported asynchronously back to the user interface application running on configuration loader interface 305. Configuration loader processor 355 is also responsible for maintaining a list of all started, canceled, suspended and completed transfer threads. In certain embodiments one or more client users are using one or more configuration loader interfaces 305. Configuration loader processor 355 controls configuration requests received from the client users while maintaining the status of all configuration transfer operations. Configuration loader processor 355 may also maintain a list, in nonvolatile storage (i.e. data base 325), of the ongoing configuration load operations. If a power failure or other error condition occurs, configuration loader module 350 has the capability to determine which operations haven't completed and restart the incomplete operations.

Thread manager 360 is responsible for maintaining all transfer threads. For each configuration transfer between a source and a target, configuration loader module 350 will spawn a single thread (i.e. threads 365-369) using configuration loader processor 355 and thread manager 360. For each configuration transfer, multiple threads may be spawned and exist at any time to apply the configuration source(s) to target information storage and retrieval system(s). There may be as many threads, or configuration transfers, at one time as memory allows. Thread manager 360 manages all currently active threads. The use of threads allows multiple configuration loads to occur simultaneously.

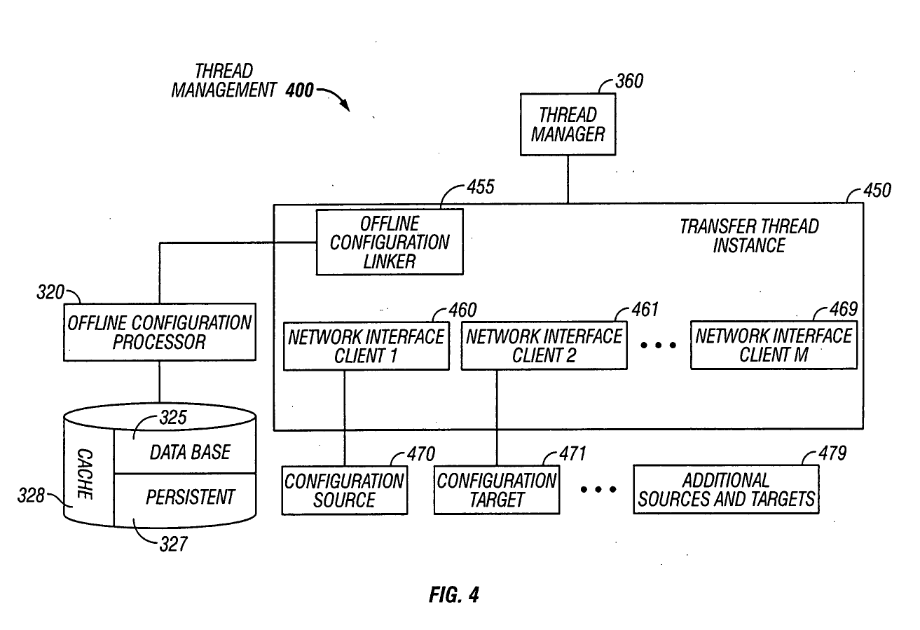

FIG. 4 shows one embodiment of a thread management system 400 for use with the present invention. In certain embodiments, each transfer thread (i.e. any one of transfer threads 365-369) spawned to execute a configuration transfer is a transfer thread instance 450. Transfer thread instance 450 connects a configuration source (i.e. configuration source 470) to a configuration target (i.e. configuration target 471) using for example, one or more network interface clients 460-469. In the preferred embodiment, a configuration may be transferred from a single source to multiple targets (for example N targets; where N is the number of targets) by creating N transfer thread instances. Alternatively, a configuration may be transferred from a single source to multiple targets by using multiple source and target network interface clients (i.e. 460-469). In addition, transfer thread instance 450 connects to database 325 through offline configuration linker 455 and offline configuration processor 320. Database 325 provides persistently maintainable configuration storage (nonvolatile storage) of source configurations, a configuration task list and cached configurations. Offline configuration processor 320 has the ability to store more than one virtual configuration image of an information storage and retrieval system. Configuration loader 301 uses offline configuration processor 320 and database 325 to store a task list of items to be transferred from a configuration source (i.e. configuration source 470) to a configuration target (i.e. configuration target 471). The task list is built by loading a configuration image from a configuration source (and verifying each object for compatibility with the configuration target). As each configuration object completes its installation on the respective configuration target, the configuration object is then removed from the task list. If or when interruptions occur (i.e. power outage, or network interrupts), the configuration loader 301 is able to determine where the configuration process was interrupted because the task list is persistently maintained in the OLC database.

In certain embodiments, each transfer thread (i.e. any one of transfer threads 365-369) is a thread executing a configuration transfer while updating the status of the configuration transfer at significant checkpoints in the process. In the preferred embodiment, the thread is a ⁱJava*™* thread. A significant checkpoint may be for example, 5% increments of progress or other user defined increments. Configuration loader 301 provides the ability to report status incrementally, at significant checkpoints; however, this capability does not have to be used to provide a configuration transfer. In certain embodiments, the configuration transfers and the respective status are maintained by Java objects. For example, each configuration transfer may be maintained within a single transfer Java object and each transfer object maintains a single status Java object. The transfer objects contain specific information about the transfers. The status objects are retrievable by the using applications executing on configuration loader user interface 305. The status objects provide methods to obtain the transfer's status. This allows using applications executing on configuration loader user interface 305 to report the status of the transfers to the users. For example, operative to a completion of the application of the configuration source to the target information storage and retrieval system, the configuration loader may communicate the status of one or more configuration transfers to the configuration loader user interface. The status of the transfer may comprise any type of statistical data about the transfers. For example, the amount of time to execute a transfer, a group of transfers, means, standard deviation, etc. for multiple transfers, the type of configuration objects transferred (i.e. ranks versus volumes), etc. Additionally, the status of any transfer complete or not may be obtained at any time.
ⁱJava and all Java-based trademarks are trademarks of Sun Microsystems, Inc. in the United States, other countries, or both.

In certain embodiments, each transfer thread creates at least two or more network interface client connections to a configuration source (i.e. configuration source 470) and to a configuration target (i.e. configuration target 471).

In certain embodiments, transferring configurations requires analyzing the physical configuration compatibility of the source and target. Before a configuration transfer can be accomplished, configuration loader 301 analyzes the source and target physical configurations to determine the physical configuration of the information storage and retrieval system configuration source and the physical configuration of the target information storage and retrieval system. Configuration loader 301 then determines if every physical object from the source has a physical counterpart on the target. If a counterpart does not exist then the transfer cannot occur because of a physical incompatibility. If the source and target are compatible then the configuration of the target may proceed by use of the Applicant's invention. In the preferred embodiment, configuration loader system 300 first verifies that each specified physical object exists on both the source and target. If all specified physical objects exist on both the source and target, the physical verification is complete and the process continues to perform a logical verification and then execute the transfer of the configuration. If the target does not contain the respective source physical object, then it is necessary to determine if a logical object needs to be transferred from the source to target within the respective physical location. If a logical object does not need to be transferred from the source to target within the respective physical location the process continues by examining the other physical objects. If a logical object does need to be transferred from the source to target within the respective physical location, verification fails and the configuration transfer does not proceed because of incompatibilities between the physical configurations. In the preferred embodiment, the physical verification is accomplished first before the logical verification/analysis may proceed.

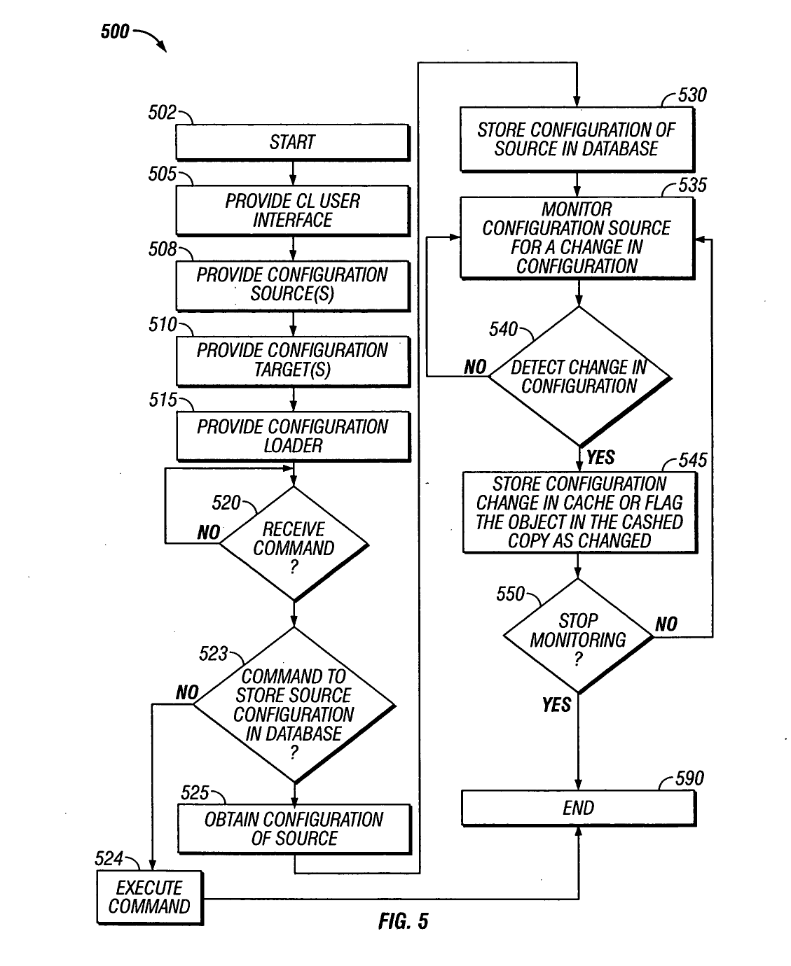

FIG. 5 summarizes certain initial steps of Applicant's method to configure information storage and retrieval systems. Referring now to FIG. 5, at step 505 the method provides a configuration loader user interface for accepting configuration commands. In the preferred embodiment, the configuration loader user interface provided may be configuration loader interface 305 described above. Configuration commands may comprise, for example, a transfer command to transfer a physical and/or logical configuration from a source to a target information storage and retrieval system. Configuration commands may additionally comprise commands to determine configurations, determine the status of a transfer, cancel a transfer, suspend a transfer, list completed transfers, list suspended transfers, list canceled transfers, list active transfers, list partial configurations, perform partial configuration transfers, resume an already started transfer or any other command needed for transferring configurations. The configuration loader user interface may accept configuration commands from a user, operator, computer system, etc.

At step 508 the method provides at least one information storage and retrieval system configuration source. An information storage and retrieval system configuration source may be a configuration maintained on, for example, any of systems 120 (FIG. 1), 130 (FIG. 1), 140 (FIG. 1). The configurations existing on the source may have been originally setup from a host computer (i.e. host(s) 105) over a network connection (i.e. network interface 180). Alternatively, the configuration could have been setup from user interface 160 through the master controller 110 and network interface 180, or combinations thereof. An information storage and retrieval system configuration source also may be a virtual or offline configuration maintained by OLC processor 320 and stored in data base 325, or combinations thereof. Each configuration source is capable of communicating with configuration loader 301.

At step 510 the method provides at least one target information storage and retrieval system. A target information storage and retrieval system may comprise, for example, any of systems 120 (FIG. 1), 130 (FIG. 1), 140 (FIG. 1), a virtual or offline configuration maintained by OLC processor 320 to be stored in data base 325, a configuration sent to configuration loader user interface 305 (FIG. 3), a configuration sent to a host computer (i.e. host(s) 105) a configuration sent over a network connection (i.e. network interface 180) or combinations thereof. Each configuration target is capable of communicating with a configuration loader 301.

At step 515 the method provides a configuration loader capable of communicating with a configuration loader user interface, with an information storage and retrieval system configuration source and with a target information storage and retrieval system. The configuration loader comprises a configuration processor, a database, and a configuration loader module for obtaining a configuration of the information storage and retrieval system configuration source. In the preferred embodiment, the offline configuration processor would be any application that is capable of managing at least one or more virtual or offline storage configurations. In the preferred embodiment, the database may be consist of any common database application program, such as DB2, Oracle, the like, or combinations thereof. In the preferred embodiment, the configuration loader may be, for example, configuration loader 301 described above. The configuration loader communicates with the configuration loader user interface, with an information storage and retrieval system configuration source and with the target information storage and retrieval system using, for example, network interface server 310 as described above. The configuration loader uses any of network interface clients 460-469 for communication with an information storage and retrieval system configuration source and with a target information storage and retrieval system. The configuration loader module for applying the configuration source to a target information storage and retrieval system may be, for example, configuration loader module 350 described above.

At step 520 the method provides a loop to wait for a configuration command. As described above, configuration commands may additionally comprise commands to determine configurations, determine the status of a transfer, cancel a transfer, suspend a transfer, list completed transfers, or any other command needed for transferring configurations. If a command is received, then control flow to step 523.

At step 523 the method provides decision to determine if the command received is to cache, or temporarily store a source configuration 470 in the database, cached memory, the like, or combinations thereof. If the command received is not to cache or store a source configuration, then control flows to step 524 to execute the command. The command executed at step 524 may comprise commands to determine configurations, determine the status of a transfer, cancel a transfer, suspend a transfer, list completed transfers, or any other command needed for transferring configurations as described above. After execution of step 524, control flows to step 550 to end.

If at step 523, the command received is a command to cache or store a source configuration, then control flows to step 525 where configuration loader module 350 obtains the configuration of the information storage and retrieval system configuration source and sends the configuration of the information storage and retrieval system configuration source to offline configuration processor 320. At step 530, offline configuration processor 320 stores the configuration of the information storage and retrieval system configuration source in database 325. In the preferred embodiment, step 530 is accomplished by instantiating a transfer thread 365 to transfer the configuration of the information storage and retrieval system configuration source to the OLC Processor 320. In this embodiment, the OLC Processor 320 would function as the target information storage and retrieval system. The configuration objects of the source information storage and retrieval system would then be transferred to OLC Processor 320, creating a new virtual offline configuration. The end result of the transfer would be the configuration of the source information storage and retrieval system cached or stored in cache memory 328, database 325, persistent 327, the like, or combinations thereof, by means of the OLC Processor 320.

Execution of steps 523, 525 and 530 may be accomplished by Applicants' system described above. For example, (1c) operative to the configuration loader 301 receiving a command from configuration loader user interface 305 to store a configuration of the information storage and retrieval system configuration source in database 325 configuration loader module 350 stores the configuration of the information storage and retrieval system configuration source in the database by executing steps 525 and 530. In the preferred embodiment, a command to cache or store a configuration is received from configuration loader user interface 305, however a command may also be received from other sources, for example, from an information storage and retrieval system (i.e. any of systems 120, 130, 140), OLC processor 320, a host computer (i.e. host(s) 105), a network connection (i.e. network interface 180) or combinations thereof.

Obtaining the configuration of the information storage and retrieval system configuration source at step 525 may be accomplished by, for example the thread management system 400 shown in FIG. 4 and described above. In the preferred embodiment, step 525 is accomplished by thread management system 400 spawning a transfer thread (i.e. transfer thread(s) 365-369) that connects a configuration source (i.e. source 470) to configuration loader module 350. The configuration of the information storage and retrieval system configuration source may then be obtained by configuration loader 301 sending a command to request the physical and/or logical configuration of a source using a source network interface client (i.e. network interface 460) connection. Each information storage and retrieval system provides a user interface for retrieving/storing and/or setting physical and/or logical configuration parameters and/or objects. The network interface clients connect to these user interfaces. A command to obtain the configuration of the information storage and retrieval system source is used to obtain information about the physical objects (i.e. number and location of disk packs, number and setting of host adapters, etc.) and/or logical objects of the source.

After execution of step 530, control flows to step 535 where the configuration loader (i.e. configuration loader 301) monitors the information storage and retrieval system configuration source to detect a change in the configuration of the information storage and retrieval system configuration source. In the preferred embodiment, configuration loader system 300 resides on master controller 110 along with the other components (i.e. web server 118 and user interface 160) used to configure logical and/or physical configurations in any of the information storage and retrieval systems 120, 130, 140. Commands are sent from user interface 160 to web server 118 to query, create, delete, and/or modify storage configuration objects (i.e. RAID arrays, volumes, etc.). The commands are then routed appropriately to one or more of the information storage and retrieval systems 120, 130, 140, to perform the actual modify or retrieval of the storage configurations objects for the respective information storage and retrieval system(s). Because these configuration commands are routed through the same network interface 162, or alternatively network interface server 310 as configuration loader system 300, then any command modifying the configuration of the respective source configuration of the source information storage and retrieval system will be monitored. If such a command is processed, it will be routed appropriately to the source configuration of the source information storage and retrieval system and also simultaneously routed to OLC Processor 320.

After execution of step 535, control flows to step 540 to detect a change in the source configuration. The process flows to step 545 if a change in the configuration of the sources is detected, otherwise control flows back to step 535 to continue monitoring the source to detect a change in the configuration. Step 545 is used to ensure that a change in the configuration of the source is maintained by the system and available when needed. The execution of step 545 may result in either storing the change in the configuration of the information storage and retrieval system configuration source in data base 325 or cache portion 328 or storing change information in the data base to indicate a change in the configuration of the information storage and retrieval system configuration source. The former case, may be accomplished by, for example, operative to configuration loader 301 detecting a change in the configuration of the information storage and retrieval system configuration source (i.e. configuration source 470), configuration loader 301 stores the change in the configuration of the information storage and retrieval system configuration source in cache portion 328. The latter case, may be accomplished by, for example, operative to configuration loader 301 detecting a change in the configuration of the information storage and retrieval system configuration source (i.e. configuration source 470), configuration loader 301 stores configuration change information in data base 325 or cache portion 328 to indicate a change in the configuration of the information storage and retrieval system configuration source. The configuration change information may be stored in data base 325, cache 328, persistent 327 or combinations thereof. The configuration change information may comprise flags indicating that a change to the logical and/or physical configuration objects were made to the source configuration. In the preferred embodiment, these flags only need to indicate that a change was made; excluding any specific information on what specifically changed. In the preferred embodiment, the flags may correspond to the change in the physical location on the information storage and retrieval systems (i.e. a logical configuration change occurred to disk group 280, number 2, on the third device adapter pair 260, 270).

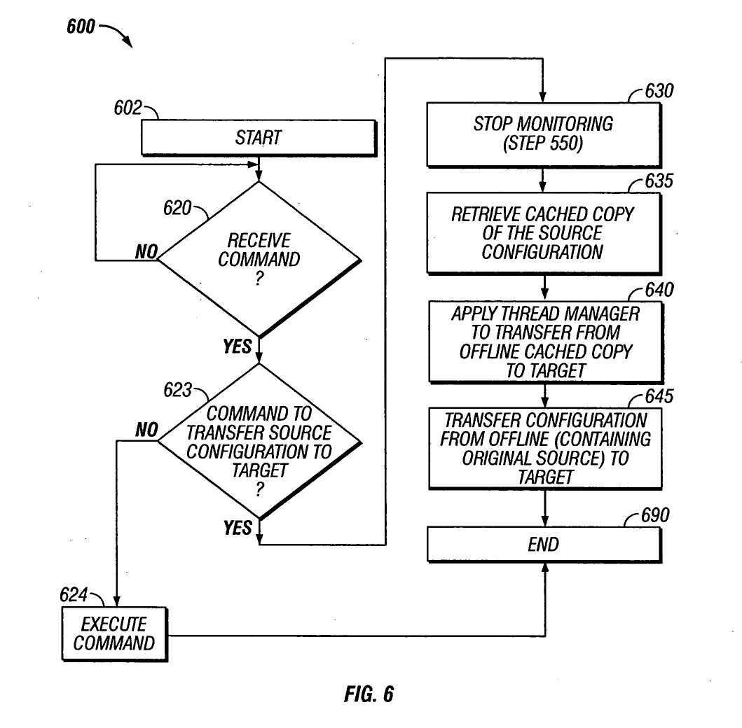

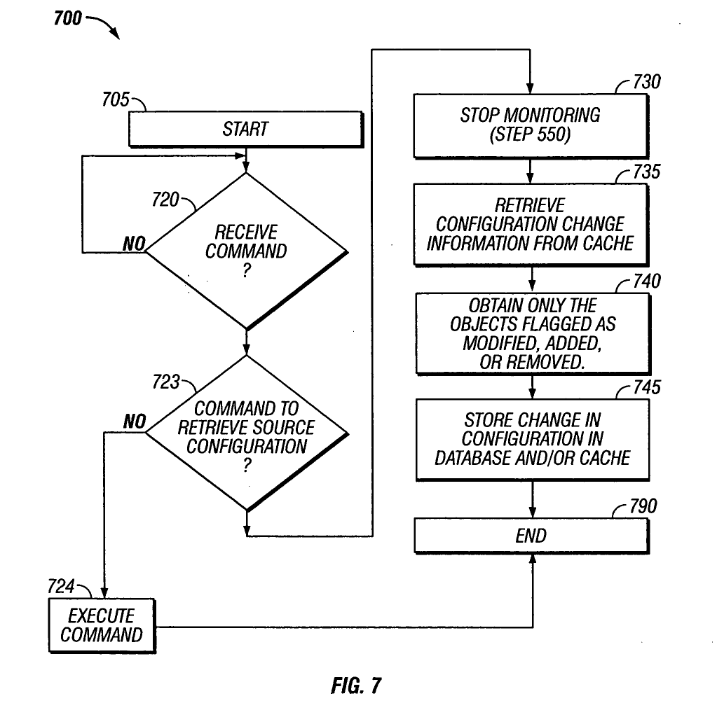

After execution of step 545, control flows to step 550 where a decision is made to stop monitoring the source for changes. The decision not to monitor the source for changes may be the result of a command received from configuration loader interface 305 or upon the execution of process 600 (FIG. 6) or process 700 (FIG. 7) described below. After execution of step 550, control flows to step 590 where the process ends.

The preceding description for process 500 above is used to provide a source configuration available for transfer to a target. Upon receipt of a command to configure a target or to retrieve a configuration of a source processes 600 (FIG. 6) or process 700 (FIG. 7) may be used to retrieve or transfer a configuration.

Processes 600 shown in FIG. 6 may be used when the execution of step 545 (described above) results in storing the change in the configuration of the information storage and retrieval system configuration source in one or more of cache portion 328, data base 325 and persistent 327. Process 600 begins with step 620 to receive a command. At step 620 the method provides a loop to wait for a configuration command. If a command is received then control flows to step 623. At step 623 the method provides a decision to determine if the command received is a command to transfer a configuration of the information storage and retrieval system configuration source to a target information storage and retrieval system. A command to transfer a configuration may comprise a command to retrieve a configuration. If the command received is not to transfer an information storage and retrieval system source configuration to a target information storage and retrieval system then control flows to step 624 to execute the command. The command executed at step 624 may comprise commands to determine configurations, determine the status of a transfer, cancel a transfer, suspend a transfer, list completed transfers, or any other command needed for transferring configurations as described above. If the command received is to transfer an information storage and retrieval system source configuration to a target information storage and retrieval system, then control flows to step 630 to stop monitoring the source. Execution of step 630 causes step 550 (FIG. 5) to transfer control to step 590. After execution of step 630, step 635 is executed to retrieve the cached source configuration from database 325, cache 328 and persistent 327 or combinations thereof. Steps 620 to 635 may be accomplished by, for example, operative to configuration loader 301 receiving a command from configuration loader user interface 305 to transfer a configuration of the information storage and retrieval system configuration source to a target information storage and retrieval system, configuration loader 301 retrieves the configuration of the information storage and retrieval system configuration source from database 325 and cache portion 328. The configuration of the information storage and retrieval system configuration source retrieved from database 325 and cache portion 328 may be, for example, the physical or logical configuration as explained above. In an alternative embodiment, only the change in the source configuration is retrieved from cache portion 328. This may be used, for example, when it is necessary to update a target configuration with only the change in the configuration. In this alternative embodiment, steps 620 to 635 may be accomplished by, for example, operative to configuration loader 301 receiving a command from configuration loader user interface 305 to retrieve a change in the configuration of the information storage and retrieval system configuration source, configuration loader 301 retrieves the change in the configuration of the information storage and retrieval system configuration source from cache portion 328. The change in the configuration of the information storage and retrieval system configuration source retrieved from cache portion 328 may be, for example, a change in the physical or logical configuration as explained above.

After execution of step 635, the information storage and retrieval system source configuration is transferred to a target information storage and retrieval system by execution of steps 640 and 645.

In the preferred embodiment the execution of steps 640 and 645 may be accomplished by applying a thread manager, such as for example, thread manager 360 of thread management system 400 (FIG. 4) described above. Thread manager 360 is used for managing at least one thread (i.e. threads 365, 366-369), wherein the thread executes step 645 to transfer the configuration of the information storage and retrieval system configuration source to a target information storage and retrieval system. As described above with reference to FIG. 4, each transfer thread (i.e. any one of transfer threads 365-369) spawned to execute a configuration transfer may be a transfer thread instance 450. In the preferred embodiment, transfer thread instance 450 connects a configuration source (i.e. configuration source 470) to a configuration target (i.e. configuration target 471) using, for example, one or more network interface clients 460-469. The source configuration of the transfer operation however, in this case, would be the configuration stored in cache portion 328, database 325, persistent 327, the like, or combinations thereof, because the entire configuration, including any changes or modifications of the original configuration image was cached.

In the alternative embodiment, where only the changed configuration objects are cached, process 700 (FIG. 7) describes the appropriate actions for a source configuration retrieval. Once a source and target are connected the configuration may proceed under the direction of, for example, transfer thread instance 450 to execute steps to accomplish the configuration transfer. In addition to connecting the sources and targets, the threads may also establish a private link/connection to OLC processor 320 and database 325. As described above, database 325 may be used to store a task list to accomplish the configuration transfer. In the preferred embodiment, at least three connections (i.e. source, target and database) are maintained during the configuration transfer. After transferring the configuration, control flows to step 690 where the process ends.

In the alternative embodiment the change in the configuration of any information storage and retrieval system configuration source may be retrieved quickly by use of a retrieval process 700 shown in FIG. 7. Processes 700 shown in FIG. 7 may be used when the execution of step 545 (described above) results in storing configuration change information in data base 325 to indicate a change in the configuration of the information storage and retrieval system configuration source. Configuration change information may be stored in data base 325, cache portion 328, persistent 327 or combinations thereof. Process 700 begins with step 720 to receive a command. At step 720 the method provides a loop to wait for a configuration command. If a command is received then control flows to step 723. At step 723 the method provides a decision to determine if the command received is to retrieve a configuration of an information storage and retrieval system configuration source. A command to retrieve a configuration may comprise a command to transfer a configuration. If the command received is not to retrieve a configuration, then control flows to step 724 to execute the command. The command executed at step 724 may comprise commands to determine configurations, determine the status of a transfer, cancel a transfer, suspend a transfer, list completed transfers, or any other command needed for transferring configurations as described above. If the command received is to retrieve a configuration of an information storage and retrieval system configuration source, then control flows to step 730 to stop monitoring the source. Execution of step 730 causes step 550 (FIG. 5) to transfer control to step 590. After execution of step 730, step 735 is executed to retrieve the configuration change information from database 325, cache 328 and persistent 327 or combinations thereof. Steps 720 to 735 may be accomplished by, for example, operative to configuration loader 301 receiving a command from configuration loader user interface 305 to retrieve a configuration of the information storage and retrieval system configuration source, configuration loader 301 retrieves the configuration change information from data base 325.

Configuration loader 301 then examines the configuration change information to determine if there is a change in the configuration of the source. If there is a change in the configuration then at step 740 configuration loader 301 obtains the change in the configuration of the information storage and retrieval system configuration source from the information storage and retrieval system configuration source and at step 745 stores the change in the configuration of the information storage and retrieval system configuration source in database 325, cache 328, persistent 327, the like, or combinations thereof. Steps 740 and 745 may be accomplished by, for example, operative to configuration loader 301 determining that the configuration change information indicates a change in the configuration of the information storage and retrieval system configuration source, configuration loader 301 obtains the change in the configuration of the information storage and retrieval system configuration source from the information storage and retrieval system configuration source and stores the change in the configuration of the information storage and retrieval system configuration source in database 325, cache 328 and persistent 327 or combinations thereof. At step 740, flags or other means may be used to identify or indicate the configuration objects that have changed. As described before, the flags indicate changes of the source configuration for a particular physical and/or logical configuration object. In the preferred embodiment, the flags may be of a Boolean type associated with a configuration object; or that of a true or false variable. Alternative embodiments may choose to implement other types of fields within the programming language constructs to indicate the change (i.e. integers, encoded values, structured fields, the like, or combinations thereof).

After execution of step 745, the information storage and retrieval system source configuration is ready to be transferred to a target information storage and retrieval system if desired and the process ends at step 790.

In certain embodiments, the operation of the present invention may be accomplished by master controller 110, on a separately network-connected computer system, such as a mainframe, personal computer, workstation, one or more of the information storage and retrieval systems, server and combinations thereof. In still other embodiments, the operation of the present invention may be accomplished by the manufacturer of the master controller, and firmware encoding that decisions disposed in a controller, such as processor 112 (FIG. 1).

In certain embodiments, the operation of the present invention may be accomplished by providing a client computer system for operation of configuration loader user interface 305.

In certain embodiments, the operation of the present invention may be accomplished by providing a server computer system in communication with the client computer system, for operation of configuration loader 301. The client and/or server computer systems may comprise a host computer, a mainframe computer, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) The client and/or computer systems may reside or be part of host(s) 105, client(s) 460-469, server 310, storage controller(s) 120-140, or any other computing system connected to or associated with data processing system 100.

In certain embodiments, an online storage controller is used as an information storage and retrieval system configuration source. For example, any of storage controllers 120, 130 and/or 140 (FIG. 1) operating online, may be used as a configuration source 470 (FIG. 4). A storage controller that is online is a storage controller that is currently operating by performing data processing operations. An online storage controller may be performing I/O operations with respect to one or more host computer systems, one or more primary or secondary storage devices and/or data cache.

In other embodiments, an offline storage controller is used as an information storage and retrieval system configuration source. For example, any of storage controllers 120, 130 and/or 140 (FIG. 1) operating offline, may be used as a configuration source 470 (FIG. 4). A storage controller that is offline is a storage controller that is not currently operating and not performing data processing operations. An offline storage controller may be in a quiesce state and not performing I/O operations with respect to one or more host computer systems, one or more primary or secondary storage devices and/or data cache. Alternatively, and in the preferred embodiment, an offline storage controller is an application program running on any computing device (i.e. host, server, PC, etc.) that simulates the configuration of a storage controller (i.e. systems 120, 130, 140). The offline storage controller may have the same configuration interface as any other storage controller's configuration interface. The offline storage controller may operate as an integrated tool that stores configuration images for more than one system or enterprise.

In other embodiments, a simulation tool is used as an information storage and retrieval system configuration source. For example, the simulation tool may be an application program on any computing device (i.e. host, server, PC, etc.) that simulates the configuration of a storage controller (i.e. systems 120,130,140). OLC Processor 320 is the core of the simulation tool. It accepts commands from configuration loader user interface 305 through network interface server 310. In the preferred embodiment, network interface clients (460, 461, 469) of a transfer thread instance 450 is given access to an offline configuration source or target maintained by a simulation tool through the network interface server 310. This connection to the simulation tool facilitates the retrieval or transfer to an offline configuration. Also, in the preferred embodiment, the transfer thread instance 450 has a direct connection to the simulation tool through offline configuration linker 455. This connection to the simulation tool is used for creating and retrieving the task list of configuration transfers.

In the operation of the present invention, Applicant's master controller receives a request, or a command, or instructions (collectively a “request”) to configure a designated second information storage and retrieval system, i.e. a “target” system, with reference to a designated first information storage and retrieval system, i.e. the “source” system. In certain embodiments, the target system comprises an extant system, such as, for example, one or more of systems 120 (FIG. 1), 130 (FIG. 1), and/or 140 (FIG. 1). In other embodiments, the target system comprises a virtual configuration image. In certain of these virtual system embodiments, the target system will be used as a simulation tool to assist the optimization of extant systems.

In certain embodiments, Applicant's invention includes instructions, where those instructions are executed by processor 112 (FIG. 1) to perform steps recited in the flowcharts shown in FIGS. 5-7.

In other embodiments, Applicant's invention includes instructions residing in any other computer program product, where those instructions are executed by a computer external to, or internal to, master controller 110. In either case, the instructions may be encoded in an information storage medium comprising, for example, a magnetic information storage medium, an optical information storage medium, an electronic information storage medium, and the like. By “electronic storage media”, Applicants mean, for example, a device such as a PROM, EPROM, EEPROM, Flash PROM, compactflash, smartmedia, and the like.

The foregoing description, for purposes of explanation, used specific nomenclature to provide a thorough understanding of the present invention. However, it will be apparent to one skilled in the art that the specific details are not required in order to practice the present invention. In other instances, well known circuits and devices are shown in block diagram form in order to avoid unnecessary distraction from the present invention. Thus, the foregoing descriptions of specific embodiments of the present invention are presented for purposes of illustration and description. They are not intended to be exhaustive or to limit the present invention to the precise forms disclosed. Obviously many modifications and variations are possible in view of the above teachings.

The present invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, MRAMs, MEMS based memory, microcode, programmable logic, etc.). Code in the computer readable medium is accessed and executed by one or more processors. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The present invention disclosed herein may be implemented as a method for deploying computing infrastructure by integrating computer readable code into a system for managing configuration information for information storage and retrieval systems. Computing infrastructure is the hardware, software, cables, power distribution, or any other components necessary for system operation. The computing infrastructure may be deployed by a service provider, hardware supplier, third party, business entity, etc. or combinations thereof. A customer may be billed and pay for the deployment of the computing infrastructure. The computer readable code in combination with the system for managing configuration information for information storage and retrieval systems (i.e. the system described above with reference to FIGS. 1-4) is capable performing operations described above with reference to FIGS. 5-7.

The logic of FIGS. 5-7 describes specific operations occurring in a particular order. In alternative implementations, certain of the logic operations may be performed in a different order, modified or removed. Moreover, steps may be added to the above described logic and still conform to the described implementations. Further, operations described herein may occur sequentially or certain operations may be processed in parallel, or operations described as performed by a single process may be performed by distributed processes.

The logic of FIGS. 5-7 was described as being implemented in software. This logic may be part of the operating system of the host systems or an application program. In yet further implementations, this logic may be maintained in storage areas managed by the control units or in a read only memory or other hardwired type of device. The preferred logic may be implemented in hard disk drives or in programmable and non-programmable gate array logic.

The embodiments were chosen and described in order to best explain the principles of the present invention and its practical applications, to thereby enable others skilled in the art to best utilize the present invention and various embodiments with various modifications as are suited to the particular use contemplated. It is intended that the scope of the present invention be defined by the following claims and their equivalents.

What is claimed is:

1. A method for managing configuration information for information storage and retrieval systems, comprising:
providing a configuration loader user interface for accepting configuration commands;
providing a configuration loader capable of communicating with said configuration loader user interface and with at least one information storage and retrieval system configuration source, said configuration loader comprising at least one offline configuration processor, at least one database and a configuration loader module for obtaining a configuration of said at least one information storage and retrieval system configuration source:
operative to said configuration loader receiving a command from said configuration loader user interface to store said configuration of said at least one information storage and retrieval system configuration source in said at least one database:
said configuration loader module obtaining said configuration of said at least one information storage and retrieval system configuration source and sending said configuration of said at least one information storage and retrieval system configuration source to said at least one offline configuration processor; and
said at least one offline configuration processor storing said configuration of said at least one information storage and retrieval system configuration source in said at least one database.

2. The method of claim 1, further comprising the step of:
providing said at least one information storage and retrieval system configuration source.

3. The method of claim 1, wherein said database further comprises a cache portion and said method further comprises:
said configuration loader monitoring said at least one information storage and retrieval system configuration source to detect a change in said configuration of said at least one information storage and retrieval system configuration source; and
operative to said configuration loader detecting said change in said configuration of said at least one information storage and retrieval system configuration source, said configuration loader storing said change in said configuration of said at least one information storage and retrieval system configuration source in said cache portion.

4. The method of claim 3, further comprising the steps of:
operative to said configuration loader receiving a command from said configuration loader user interface to transfer said configuration of said at least one information storage and retrieval system configuration source to a target information storage and retrieval system:
said configuration loader retrieving said configuration of said at least one information storage and retrieval system configuration source from said database and said cache portion.

5. The method of claim 4, further comprising the step of:
applying a thread manager for managing at least one thread, wherein said at least one thread transfers said configuration of said at least one information storage and retrieval system configuration source to said target information storage and retrieval system.

6. The method of claim 3, further comprising the steps of:
operative to said, configuration loader receiving a command from said configuration loader user interface to retrieve said change in said configuration of said at least one information storage and retrieval system configuration source:
said configuration loader retrieving said change in said configuration of said at least one information storage and retrieval system configuration source from said cache portion.

7. The method of claim 1, wherein said database further comprises a cache portion and said method further comprises:
said configuration loader monitoring said at least one information storage and retrieval system configuration source to detect a change in said configuration of said at least one information storage and retrieval system configuration source;
operative to said configuration detecting said change in said configuration of said at least one information storage and retrieval system configuration source:
said configuration loader storing configuration change information in said data base to indicate said change in said configuration of said at least one information storage and retrieval system configuration source.

8. The method of claim 7, further comprising the steps of:
operative to said configuration loader receiving a command from said configuration loader user interface to retrieve said configuration of said at least one information storage and retrieval system configuration source:
said configuration loader retrieving said configuration change information from said data base;
operative to said configuration loader determining that said configuration change information indicates said change in said configuration of said at least one information storage and retrieval system configuration source:
said configuration loader obtaining said change in said configuration of said at least one information storage and retrieval system configuration source from said at least one information storage and retrieval system configuration source; and
said configuration loader storing said change in said configuration of said at least one information storage and retrieval system configuration source in said database.

9. The method of claim 1, further comprising:
using an online storage controller as said at least one information storage and retrieval system configuration source.

10. The method of claim 1, further comprising:
using an offline storage controller as said at least one information storage and retrieval system configuration source.

11. The method of claim 1, further comprising:
using a simulation tool as said at least one information storage and retrieval system configuration source.

12. A system for managing configuration information for information storage and retrieval systems, comprising:
a configuration loader user interface for accepting configuration commands; and
a configuration loader capable of communicating with said configuration loader user interface and with at least one information storage and retrieval system configuration source, said configuration loader comprising at least one offline configuration processor, at least one database and a configuration loader module for obtaining a configuration of said at least one information storage and retrieval system configuration source.

13. The system of claim 12, where said system is adapted to execute steps comprising:
operative to said configuration loader receiving a command from said configuration loader user interface to store said configuration of said at least one information storage and retrieval system configuration source in said at least one database:
said configuration loader module obtaining said configuration of said at least one information storage and retrieval system configuration source and sending said configuration of said at least one information storage and retrieval system configuration source to said at least one offline configuration processor; and
said at least one offline configuration processor storing said configuration of said at least one information storage and retrieval system configuration source in said at least one database.

14. The system of claim 13, further comprising a cache portion and where said system is adapted to execute steps further comprising:
said configuration loader monitoring said at least one information storage and retrieval system configuration source to detect a change in said configuration of said at least one information storage and retrieval system configuration source; and
operative to said configuration loader detecting said change in said configuration of said at least one information storage and retrieval system configuration source, said configuration loader storing said change in said configuration of said at least one information storage and retrieval system configuration source in said cache portion.

15. The system of claim 14, where said system is adapted to execute steps further comprising:
operative to said configuration loader receiving a command from said configuration loader user interface to transfer said configuration of said at least one information storage and retrieval system configuration source to a target information storage and retrieval system:
said configuration loader retrieving said configuration of said at least one information storage and retrieval system configuration source from said database and said cache portion.

16. The system of claim 15, further comprising
a thread manager for managing at least one thread, wherein said at least one thread transfers said configuration of said at least one information storage and retrieval system configuration source to said target information storage and retrieval system.

17. The system of claim 14, where said system is adapted to execute steps further comprising:
operative to said configuration loader receiving a command from said configuration loader user interface to retrieve said change in said configuration of said at least one information storage and retrieval system configuration source:
said configuration loader retrieving said change in said configuration of said at least one information storage and retrieval system configuration source from said cache portion.

18. The system of claim 13, further comprising a cache portion and where said system is adapted to execute steps further comprising:
said configuration loader monitoring said at least one information storage and retrieval system configuration source to detect a change in said configuration of said at least one information storage and retrieval system configuration source;
operative to said configuration detecting said change in said configuration of said at least one information storage and retrieval system configuration source:
said configuration loader storing configuration change information in said data base to indicate said change in said configuration of said at least one information storage and retrieval system configuration source.

19. The system of claim 18, where said system is adapted to execute steps further comprising:
operative to said configuration loader receiving a command from said configuration loader user interface to retrieve said configuration of said at least one information storage and retrieval system configuration source:
said configuration loader retrieving said configuration change information from said data base;
operative to said configuration loader determining that said configuration change information indicates said change in said configuration of said at least one information storage and retrieval system configuration source:
said configuration loader obtaining said change in said configuration of said at least one information storage and retrieval system configuration source from said at least one information storage and retrieval system configuration source; and
said configuration loader storing said change in said configuration of said at least one information storage and retrieval system configuration source in said database.

20. The system of claim 12, further comprising:
an online storage controller for use as said at least one information storage and retrieval system configuration source.

21. The system of claim 12, further comprising:
an offline storage controller for use as said at least one information storage and retrieval system configuration source.

22. The system of claim 12, further comprising:
a simulation tool for use as said at least one information storage and retrieval system configuration source.

23. An article of manufacture comprising a data storage medium tangibly embodying a program of machine-readable instructions executable by a system for managing configuration information for information storage and retrieval systems, said system comprising:
a configuration loader user interface for accepting configuration commands; and
a configuration loader capable of communicating with said configuration loader user interface and with at least one information storage and retrieval system configuration source, said configuration loader comprising at least one offline configuration processor, at least one database and a configuration loader module for obtaining a configuration of said at least one information storage and retrieval system configuration source, where said program of machine-readable instructions causes:
operative to said configuration loader receiving a command from said configuration loader user interface to store said configuration of said at least one information storage and retrieval system configuration source in said at least one database:
said configuration loader module obtaining said configuration of said at least one information storage and retrieval system configuration source and sending said configuration of said at least one information storage and retrieval system configuration source to said at least one offline configuration processor; and
said at least one offline configuration processor storing said configuration of said at least one information storage and retrieval system configuration source in said at least one database.

24. The article of manufacture of claim 23 where said system further comprises a cache portion and said program of machine-readable instructions further causes:
said configuration loader monitoring said at least one information storage and retrieval system configuration source to detect a change in said configuration of said at least one information storage and retrieval system configuration source; and
operative to said configuration loader detecting said change in said configuration of said at least one information storage and retrieval system configuration source, said configuration loader storing said change in said configuration of said at least one information storage and retrieval system configuration source in said cache portion.

25. The article of manufacture of claim 24 where said program of machine-readable instructions further causes:
operative to said configuration loader receiving a command from said configuration loader user interface to transfer said configuration of said at least one information storage and retrieval system configuration source to a target information storage and retrieval system:
said configuration loader retrieving said configuration of said at least one information storage and retrieval system configuration source from said database and said cache portion.

26. The article of manufacture of claim 25 where said system further comprises a thread manager for managing at least one thread, and where said program of machine-readable instructions further causes:
said at least one thread to transfer said configuration of said at least one information storage and retrieval system configuration source to said target information storage and retrieval system.

27. The article of manufacture of claim 24 where said program of machine-readable instructions further causes:
operative to said configuration loader receiving a command from said configuration loader user interface to retrieve said change in said configuration of said at least one information storage and retrieval system configuration source:
said configuration loader retrieving said change in said configuration of said at least one information storage and retrieval system configuration source from said cache portion.

28. The article of manufacture of claim 23 where said system further comprises a cache portion and said program of machine-readable instructions further causes:
said configuration loader monitoring said at least one information storage and retrieval system configuration source to detect a change in said configuration of said at least one information storage and retrieval system configuration source;
operative to said configuration detecting said change in said configuration of said at least one information storage and retrieval system configuration source:
said configuration loader storing configuration change information in said data base to indicate said change in said configuration of said at least one information storage and retrieval system configuration source.

29. The article of manufacture of claim 28 where said program of machine-readable instructions further causes:
operative to said configuration loader receiving a command from said configuration loader user interface to retrieve said configuration of said at least one information storage and retrieval system configuration source:
said configuration loader retrieving said configuration change information from said data base;
operative to said configuration loader determining that said configuration change information indicates said change in said configuration of said at least one information storage and retrieval system configuration source:
said configuration loader obtaining said change in said configuration of said at least one information storage and retrieval system configuration source from said at least one information storage and retrieval system configuration source; and
said configuration loader storing said change in said configuration of said at least one information storage and retrieval system configuration source in said database.

30. A method for deploying computing infrastructure, comprising integrating computer readable code into a system for managing configuration information for information storage and retrieval systems, wherein the code in combination with said system is capable of performing the following:
operative to a configuration loader receiving a command from a configuration loader user interface to store a configuration of at least one information storage and retrieval system configuration source in at least one database:
said configuration loader module obtaining said configuration of said at least one information storage and retrieval system configuration source and sending said configuration of said at least one information storage and retrieval system configuration source to at least one offline configuration processor; and
said at least one offline configuration processor storing said configuration of said at least one information storage and retrieval system configuration source in said at least one database.

31. The method of claim 30, wherein the code in combination with said system is further capable of performing the following:
said configuration loader monitoring said at least one information storage and retrieval system configuration source to detect a change in said configuration of said at least one information storage and retrieval system configuration source; and
operative to said configuration loader detecting said change in said configuration of said at least one information storage and retrieval system configuration source, said configuration loader storing said change in said configuration of said at least one information storage and retrieval system configuration source in a cache portion.

32. The method of claim 31, wherein the code in combination with said system is further capable of performing the following:
operative to said configuration loader receiving a command from said configuration loader user interface to transfer said configuration of said at least one information storage and retrieval system configuration source to a target information storage and retrieval system:
said configuration loader retrieving said configuration of said at least one information storage and retrieval system configuration source from said database and said cache portion.

33. The method of claim 32, wherein the code in combination with said system is further capable of performing the following:
applying a thread manager for managing at least one thread, wherein said at least one thread transfers said configuration of said at least one information storage and retrieval system configuration source to said target information storage and retrieval system.

34. The method of claim 31, wherein the code in combination with said system is further capable of performing the following:
operative to said configuration loader receiving a command from said configuration loader user interface to retrieve said change in said configuration of said at least one information storage and retrieval system configuration source:
said configuration loader retrieving said change in said configuration of said at least one information storage and retrieval system configuration source from said cache portion.

35. The method of claim 30, wherein the code in combination with said system is further capable of performing the following:
said configuration loader monitoring said at least one information storage and retrieval system configuration source to detect a change in said configuration of said at least one information storage and retrieval system configuration source;
operative to said configuration detecting said change in said configuration of said at least one information storage and retrieval system configuration source:
said configuration loader storing configuration change information in said data base to indicate said change in said configuration of said at least one information storage and retrieval system configuration source.

36. The method of claim 35, wherein the code in combination with said system is further capable of performing the following:
operative to said configuration loader receiving a command from said configuration loader user interface to retrieve said configuration of said at least one information storage and retrieval system configuration source:
said configuration loader retrieving said configuration change information from said data base;
operative to said configuration loader determining that said configuration change information indicates said change in said configuration of said at least one information storage and retrieval system configuration source:
said configuration loader obtaining said change in said configuration of said at least one information storage and retrieval system configuration source from said at least one information storage and retrieval system configuration source; and
said configuration loader storing said change in said configuration of said at least one information storage and retrieval system configuration source in said database.
